(19) United States
(12) Patent Application Publication
(10) Pub. No.: US 2002/0145022 A1
(43) Pub. Date: Oct. 10, 2002

(54) Foldable utility container / carrier

(76) Inventors: Hung Van Nguyen, Walnut, CA (US); Thong Dang, Yorba Linda, CA (US)

Correspondence Address: PRODUMAGINEERING, 21035 EAGLES NEST DR., YORBA LINDA, CA, 92886, US

(21) Appl. No.: 09/825,983

(22) Filed: Apr. 5, 2001

(51) Int. Cl. B60R 5/00; B65D 6/18

(52) U.S. Cl. 224/539; 224/925; 220/4.29

(57) ABSTRACT

A foldable utility container/carrier is an inexpensive device, fully assemble in fold condition readily for use in the sport utility vehicles, vans or open-bed trucks for carrying bags of groceries and the like items without tilting or shifting when vehicle is in motion. Equipped with Velcro pads and magnets on the outside panels, the foldable utility container/carrier can be storage or used in the cargo area of a vehicle where material such as fabric, floor mat, carpet or bare metal are present. The foldable utility container/carrier is made up of Polypropylene material and comprising of six pre-assembled foldable panels- Four verticals and two bottoms with dividers. Within a manner of seconds, the foldable utility container/carrier can be folded for storage or extended for use.

The claimed foldable utility container/carrier is a compact design, quick fold for storage, light weigh with Polypropylene as the material for ease of handling and manufacturing- The FUCC mainly used as a container or a carrier of bags of groceries and the like items in the cargo area of a sport utility vehicle, van or open-bed ttuck. With Velcro pad provided on the outside wall of the long, the short, the bottom panels, and also with Velcro and magnet pads provided underneath the bottom panels, the FUCC can be attached firmly in the cargo area, either in fold for storage, or expand with full load of bags of groceries or the like items without tipping or shifting when the vehicle is in motion.

### CROSS REFERENCES

U.S. Pat. No. 4,718,584 to Schoeny, discloses an automotive accessory for use in the hatchback automobiles and station wagons. The patent includes a base, and two side flaps swingably attached to the back flap which formed open-topped enclosures for retaining small articles.

U.S. Pat. No. 5,5526,972 to Frazier and Davis, discloses a space organizer for truck bed trays and automobile trunks. The patent includes a backboard with two wing-kike partition members that can be formed into multiple sections for organizing items.

U.S. Pat. No. 5,215,205 to Behlman, discloses an article organizer. The patent includes a plurality of wall members disconnectably connected together at their ends to form a closed perimeter wall of predetermined configuration.

U.S. Pat. 5,518,170 to Rasmussen, discloses a collapsible storage pen. The patent includes a segmented peripheral wall and interior wall segments being connected to the peripheral wall which form a collapsible storage pen.

U.S. Pat. 6,135,332 to Eleam, discloses a collapsible storage basket. The patent includes opposite side panels and a pair of end panels extending between the side panels. Lower edges of each of the side and end panels are coupled to a rear surface of a back seat.

### BACKGROUND OF THE INVENTION

Developing a device that can be folded flat for storage, and within a manner of seconds, it can be fully expanded to containing and to carrying bags of groceries and the like items in the cargo area of a vehicle without falling or tipping is a big challenging.

The present invention related to the foldable utility container/carrier. The FUCC is made up of Polypropylene material, durable and light in weight. Said the foldable utility container/carrier comprises of six fully assembled panels with dividers for containing small bags of groceries or the like small items if desired. With all panels and dividers are fully assembled, within a manner of seconds, the FUCC can be folded flat for storage, fully expanded for use or for carrying bags of groceries or the like items to the final destination from a sport utility vehicle, van, or open-bed truck. With Velcro pad provided on the outside wall of the long panel, the short panel, and magnet pad on both bottom panels, the FUCC when folded can be firmly attached to the back of the rear seat or on the inside wall of the trunk in the cargo area of a Sport Utility Vehicle, van or open-bed truck.

Known prior art includes U.S. Pat. No. 4,718,584; U.S. Pat. No. 5,5526,972; U.S. Pat. No. 5,215,205; U.S. Pat. No. 5,518,170; U.S. Pat. No. 5,135,332. While these devices fulfill their respective, particular objectives and requirement, the aforementioned patents do not disclose a new foldable utility container/carrier. In these respect, the foldable utility container/carrier accordingly to the invention substantially separates itself from the concepts and designs of the prior art.

### SUMMARY OF THE INVENTION

This invention relates to the foldable utility container/carrier (FUCC) for use to contain bags of groceries and the like items in the cargo area of a sport utility vehicle, van or open-bed truck. In a sport utility or van, with Velcro pads provided on the outside walls, when not in use, the FUCC can be folded flat and firmly attached to the back side of the rear seat or to the back of the trunk. When ready for use, the FUCC can be fully expanded from the current folded storage position. With two additional Velcro pads provided on the bottom of the bottom panels, the FUCC is fully secured in the vehicle cargo area with full of bags of groceries or the like items without tipping or shifting when the vehicle is in motion.

In the open-bed truck, when not in use, the FUCC can be folded flat and storage between the cabin rear wall and the driver seat. With two magnet pads provided on the bottom of the bottom panels, in addition to two bungee cords that user provided, the FUCC is fully secured to the cargo area without tipping or shifting with full loads of goods when the truck is in motion.

With cutout provided on the short panels, the FUCC can be easily carried with full load of bags of groceries to the final destination. And with a manner of seconds, the FUCC can easily be reconfigure to the previous fold and storage condition.

The FUCC comprises of 6 panels and two dividers. All panels and dividers are constructed with polypropylene material, fully pre-assembled for ease of folding, expanding and carrying. The FUCC is designed to carry up to 50 pounds groceries or the like items.

### BRIEF DESCRIPTION OF THE DRAWINGS

The above background and summary of the invention may be more clearly seen when viewed in conjunction with the accompanying drawings wherein:

FIG. 1 is a perspective view of the invention in expanded position for use;

FIG. 2 is a perspective view of the invention in folded position for storage;

FIG. 3 shows assembly method of the bottom panel and divider;

FIG. 4 shows assembly method of the bottom panel and short panel;

FIG. 5 shows assembly method of the long and the short panel;

FIG. 6 shows final assembly method;

FIG. 7 is a perspective view of the invention in expanded position for use-Attach to the back of the rear seat in a van or in a sport utility vehicle;

FIG. 8 is a perspective view of the invention in folded for storage- Attach to the rear seat in a van or in a sport utility vehicle;

FIG. 9 is a perspective view of the invention in expanded position for use- Attach to the trunk in a van or a sport utility vehicle;

FIG. 10 is a perspective view of the invention in folded position for storage- Attach to the trunk in a van or a sport utility vehicle;

FIG. 11 shows a perspective view of the invention in expanded position-On the cargo area of an open-bed truck;

FIG. 12 shows a perspective view of the invention in folded position for storage-Behind the driver seat.

### DETAILED DESCRIPTION OF THE INVENTION

Referring now to the drawings, the invention as shown in FIG. 1 comprises a vehicle foldable utility container/carrier 1 in full expanded condition. The foldable utility container/carrier 1 shown comprises of the long panels 2a and 2b, the short panels 3a and 3b, and the bottom panels 4a and 4b with the divider 5a and 5b are in the upright position. Pins 6, 7 and 8 are permanently used to hinged panels 2a, 2b, 3a, 3b, 4a, 4b and dividers 5a and 5b as a complete unit. The overall dimension of the fully expanded foldable utility container/carrier 1 shown in FIG. 1 are approximately 24 inches long by 15 inches wide by 12 inches high and will fit up to 3 standard size bags of full groceries. The first set of the Velcro pads 9 on the outside of the long panel 2a and the short panel 3a are used to secure the fully folded foldable utility container/carrier 1 to the back side of the rear seat 12, or to the back side of the trunk 13 or on the cargo area 11 of a sport utility vehicle or a van 22. The second set of the Velcro pads 9 on underneath of the bottom panels 4a and 4b are used to secure the fully expanded foldable utility container/carrier 1 onto the cargo area 11. The third set of the magnet 10 also on underneath of the bottom panels 4a and 4b are used to secure the fully expanded foldable utility container/carrier 1 onto the cargo area 16 of an open-bed truck 23. The foldable utility container/carrier 1 can be folded and stored behind the driver seat 21 when not in use in an open-bed truck 23. Four ½ inch holes 17 on the short panels 3a and 3b are the provision for user to secure the fully expanded foldable utility container/carrier 1 to the cargo area 16 with bungee cords 15.

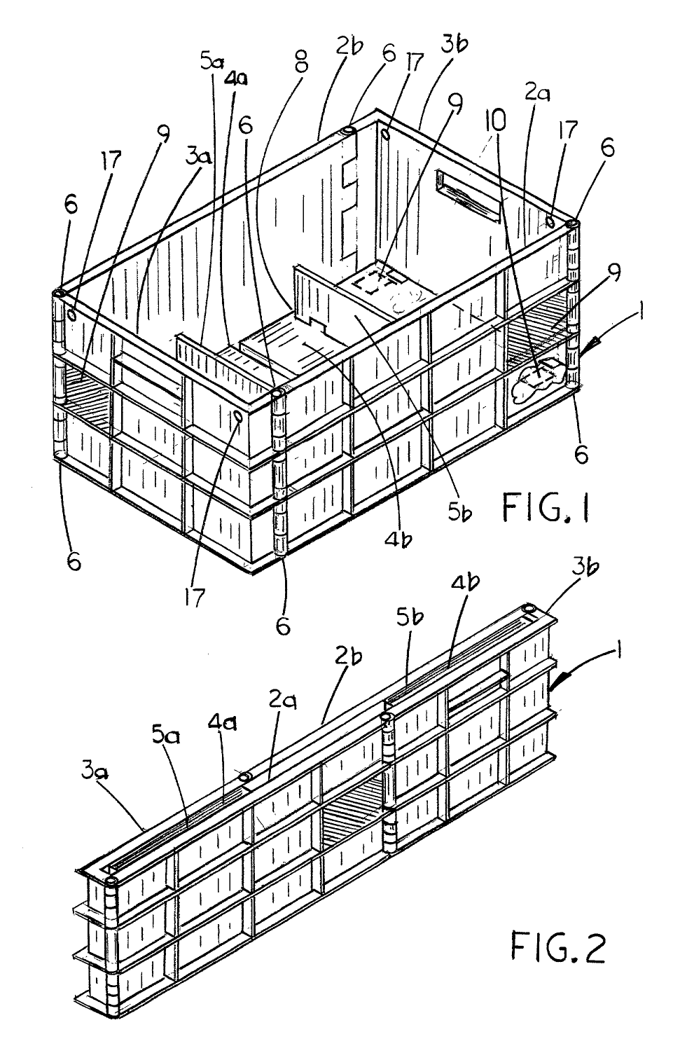

FIG. 2 shows the foldable utility container/carrier 1 in folded position readily for storage in a vehicle or in a remote location. To complete folding the foldable utility container/carrier 1, first fold the bottom panel 4a and 4b upward against the long panels 2a and 2b with both dividers 5a and 5b in fold position. Second fold the short panel 3a and the long panel 2b against the long panel 2a and the short panel 3b. The approximate dimensions of the foldable utility container/carrier 1 are 36⅝ inches long by 12 inches high by 2⅜ inches thick when fold, Thus the foldable utility container/carrier 1 can be easily stored, used or carried in a sport utility vehicle, van or an open-bed truck.

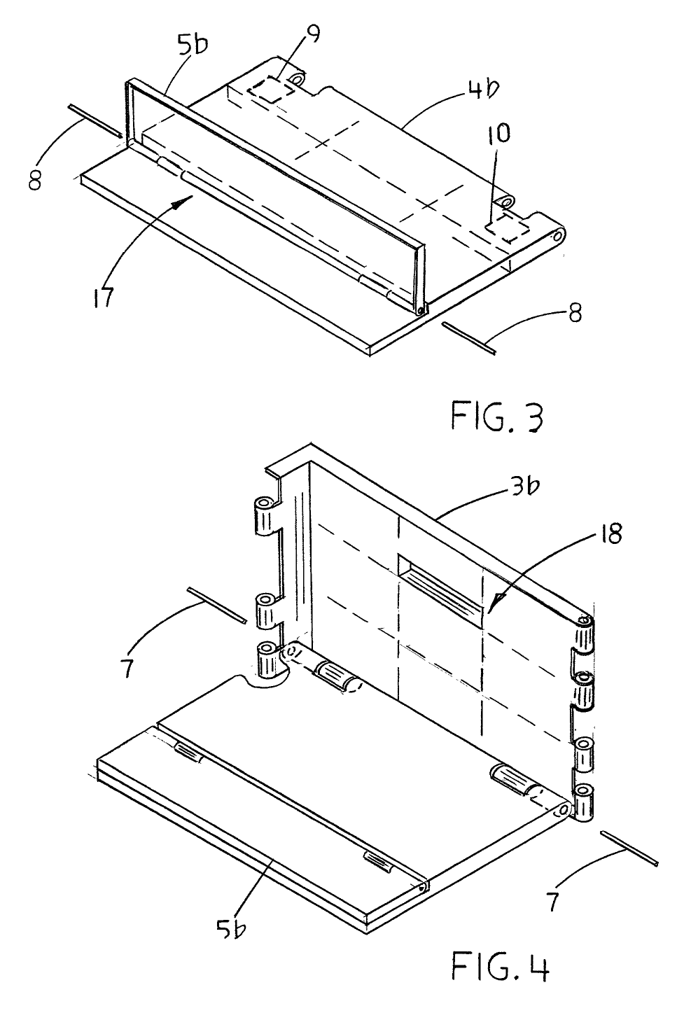

FIG. 3 shows the perspective view of the sub-assembly 17. Sub-assembly 17 comprises of bottom panel 4b with Velcro pad 9 and magnet pad 10 installed on the bottom. Two are used to secure the divider 5b into the bottom panel 4b.

FIG. 4 shows the perspective view of the sub-assembly 18. Sub-assembly 18 comprises of subassembly 17 as shown in FIG. 3 with divider 5b is in fold position and the short panel 3b. Two pins 7 are used to secure the short panel 3b into the sub-assembly 17.

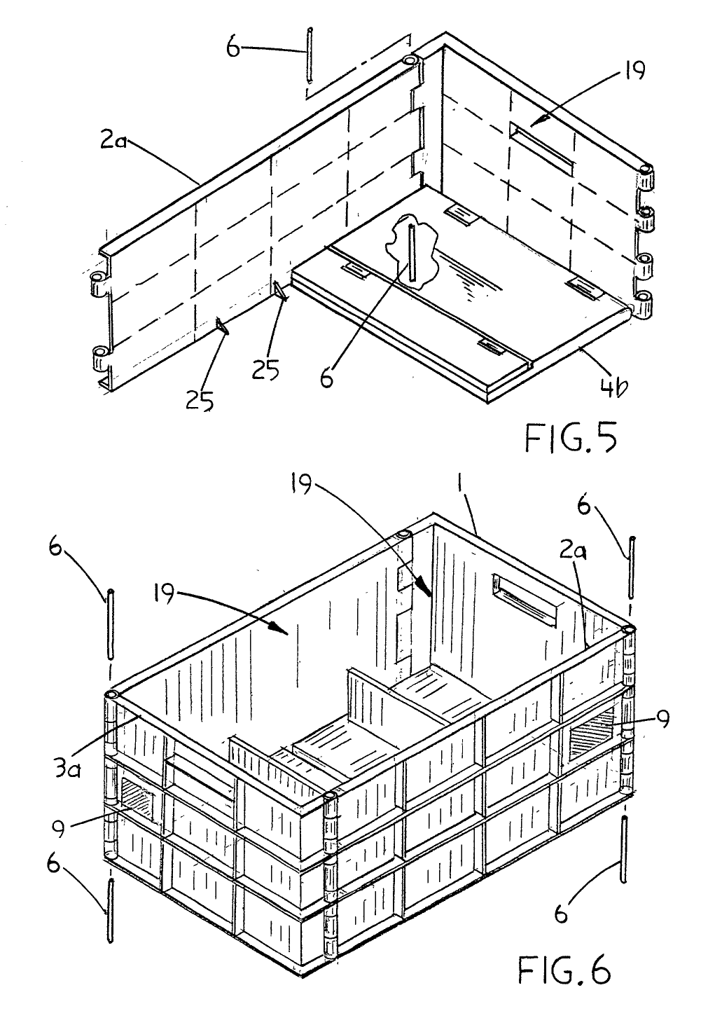

FIG. 5 shows the perspective view of the sub-assembly 19. Sub-assembly 19 comprises of subassembly 18 as shown in FIG. 4 and the long panel 2a. Two pins 6 are used to secure the long panel 2a into the sub-assembly 18. Four stoppers 25 on the inside, along the bottom edge of the long panel 2a are used to stop and to support the bottom panel 4b in fully expanded position.

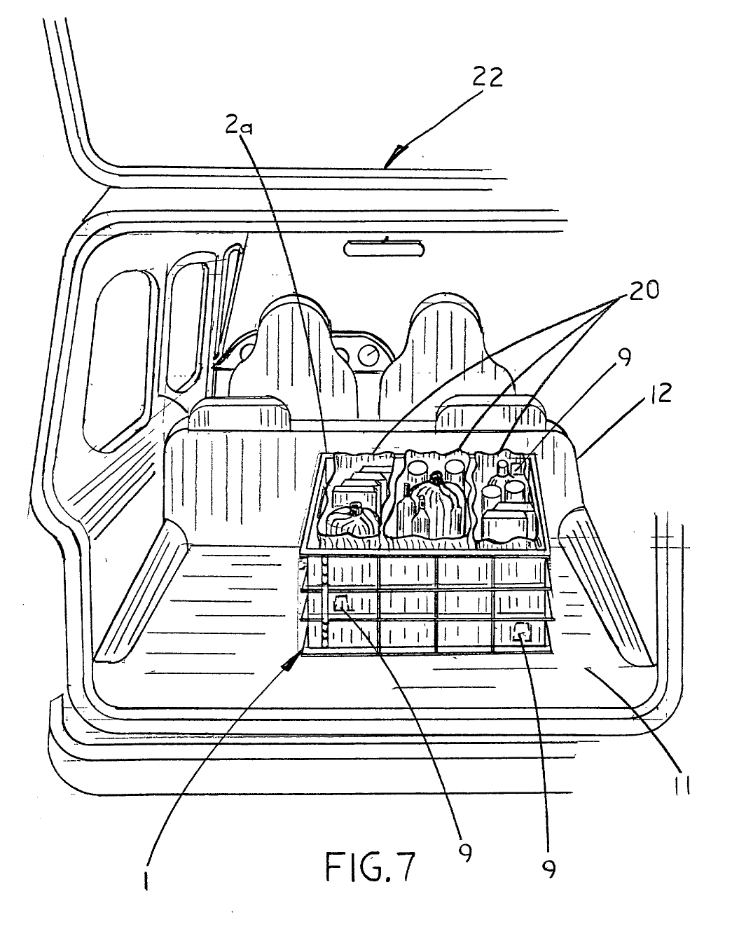

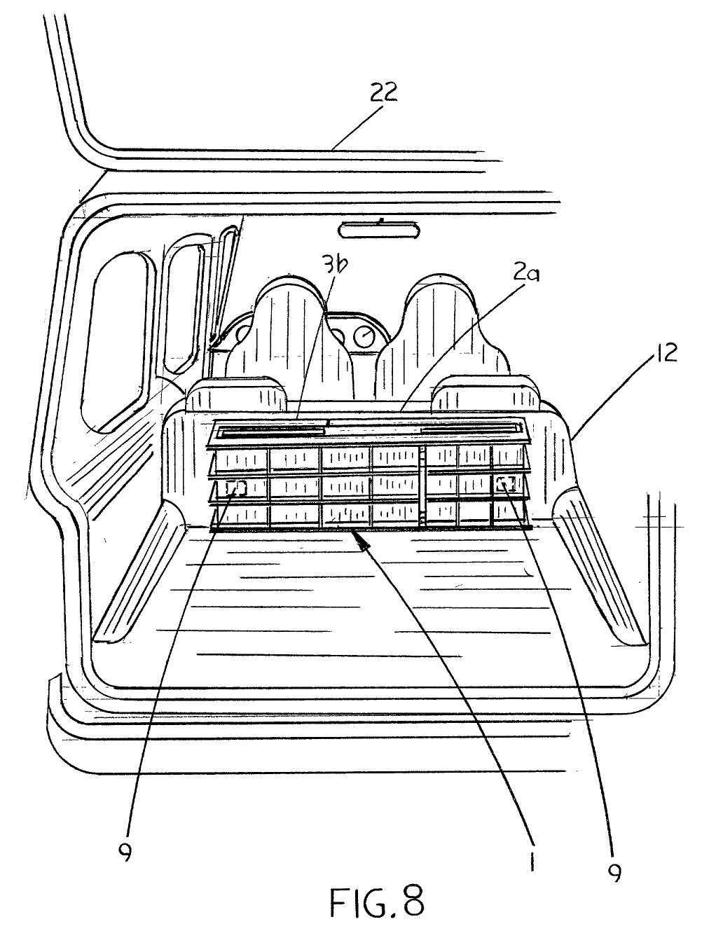

FIG. 6 shows the perspective view of the final assembly of the foldable utility container/carrier 1. Two sub-assemblies 19 and four pins 6 are used to complete the final assembly of the foldable utility container/carrier 1. Only one sub-assembly 19 having Velcro pads 9 installed- One is on the short panel 3a and other is on the long panel 2a.

FIG. 7 shows a partial perspective view around the rear seat 12 in upright position of a van or a sport utility vehicle 22. The foldable utility container/carrier 1 is in use with 3 full bags of groceries 20. As shown in the view, the foldable utility container/carrier 1 is firmly secured to the cargo area 11 with two Velcro pads 9 located underneath the bottom panels 4a and 4b. Other Velcro pad 9 on the outside of the long panel 2a is also used to attach the foldable utility container/carrier 1 into the wall of the rear seat 12. With three Velcro pads 9, the foldable utility container/carrier 1 is firmly secured without shifting or tilting during the vehicle such as van or sport utility vehicle 22 is in motion.

FIG. 8 shows a partial perspective view around the rear seat 12 in upright position of a van or a sport utility vehicle 22 with the foldable utility container/ carrier I is in folded position for storage. As shown in the view, two Velcro pads 9-One on the long-panel 2a, and other on the short-panel 3b are used to secure the foldable utility container/carrier 1 onto the back side of the rear seat 12.

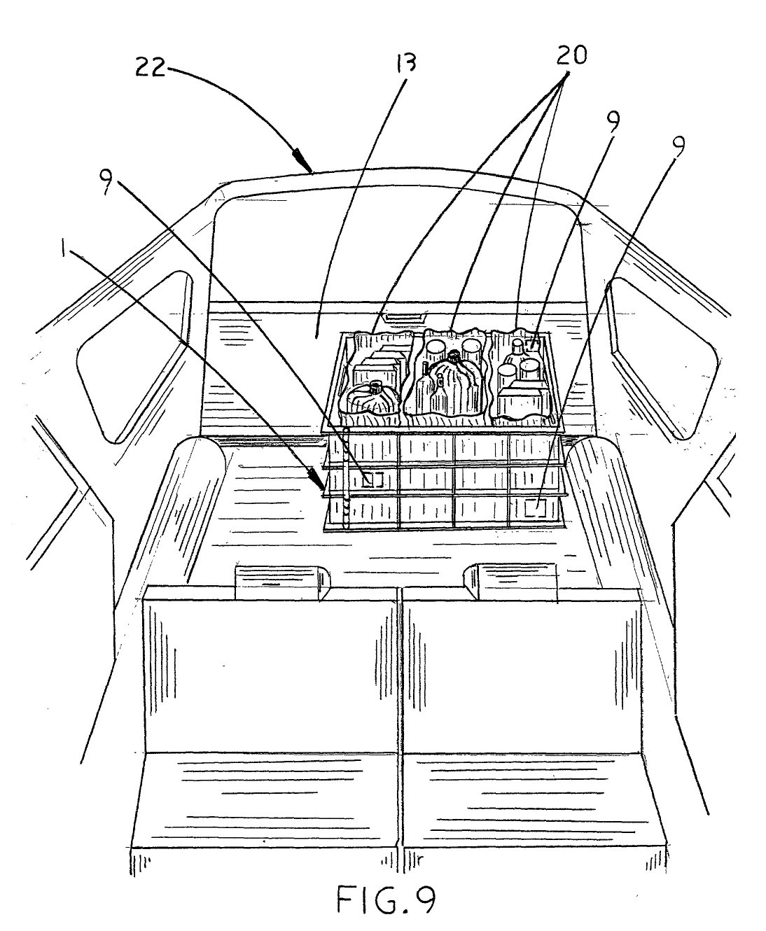

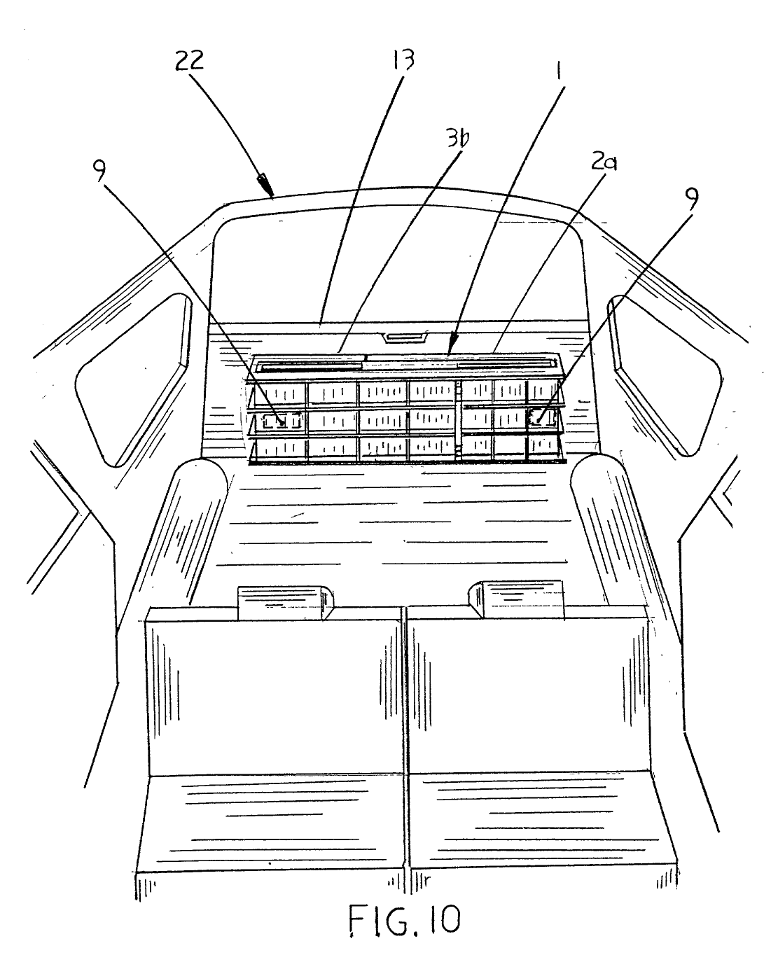

FIG. 9 shows a partial perspective view around the trunk 13 of a van or a sport utility vehicle 22. The foldable utility container/carrier 1 is in use with three bags of groceries 20. As shown in the view, the foldable utility container/carrier 1 is firmly secured to the cargo area 11, and with two Velcro pads 9 located underneath the bottom panels 4a and 4b. Other Velcro pad 9 on the outside of the long-panel 2a is also used to attach the foldable utility container/carrier 1 into the backside of the trunk 13. With three Velcro pads 9, the foldable utility container/carrier 1 is firmly secured without shifting or tilting during the vehicle such as van or sport utility vehicle 22 is in motion.

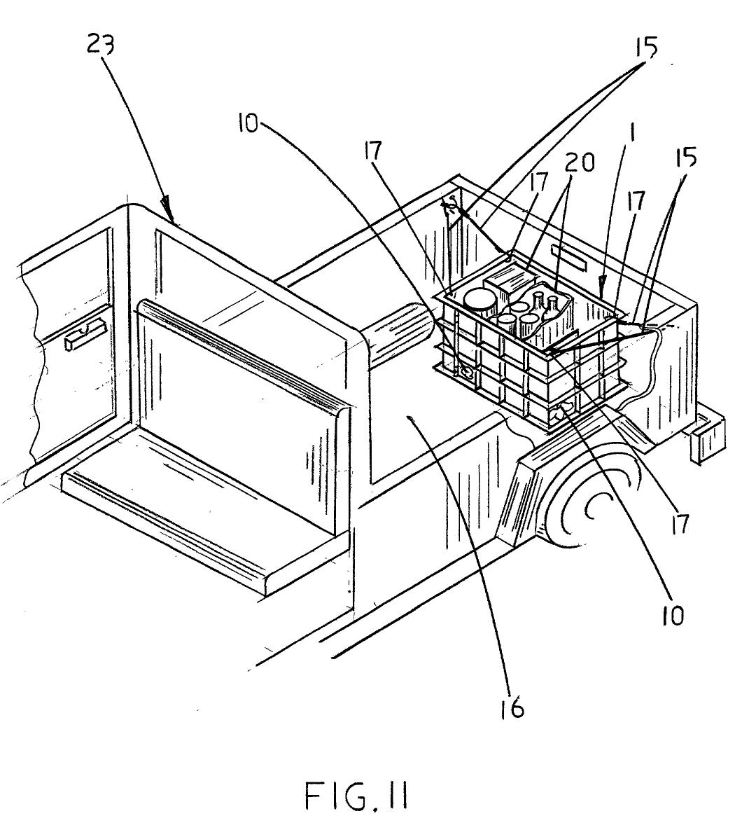

FIG. 10 shows a partial perspective view around the trunk 13 of a van or a sport utility vehicle 22 with the foldable utility container/carrier 1 is in folded position for storage. As shown in view, two Velcro pads 9-One on the long panel 2a, and other on the short panel 3b are used to secure the foldable utility container/carrier I onto the back side of the trunk 13.

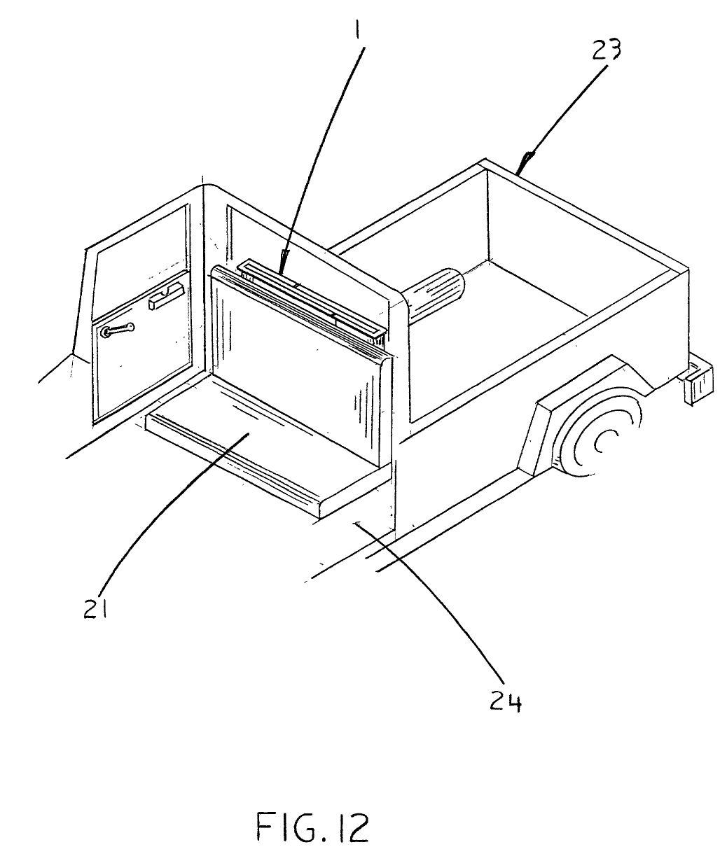

FIG. 11 shows a partial perspective view in the back of the cargo area 16 of an open-bed truck 23. The foldable utility container/carrier 1 is in use with fill of bags of groceries 20 As shown in the view, the foldable utility container/carrier 1 is firmly secured to the metal-base cargo area 16 with two magnet pads 10 located underneath the bottom panels 4a and 4b. If the cargo area 16 is supplied with plastic liner, user can use bungee cords 15 utilizing holes 17 located on the short

1. A foldable utility container/carrier for use in vehicles made up of Polypropylene material comprising:
A pair of long panels, said long panels, one is provided with Velcro pad only; A pair of short panel, said short panels, one is provided with Velcro pad only; A pair of bottom panels, said bottom panels each providing with a Velcro pad and magnet pad. Also said bottom panel each having divider built-in. All said long panels, short panels and dividers are fully assembled for ease of folding, expanding, and carrying.

2. A foldable utility container/carrier in accordance with claim 1 wherein:
Each long panel comprises a plurality of similar ribs on the outside surface, along the vertical and the horizontal direction for strength. Said long panel with one end having two male plugs, other end having one male plug and one female slot to engage a corresponding slot or plug in the short panel. Also said long panel having four stoppers on the inside surface, along the bottom edge for supporting the bottom panel when said bottom panel is in fully expanded position.

3. A foldable utility container/carrier in accordance with claim 2 wherein:
The plurality of ribs comprises of 12 compartments. Said compartments having 4 rows in the vertical direction, and 3 rows in the horizontal direction. The middle compartment of the most outer row is provided with Velcro pad.

4. A foldable utility container/carrier in accordance with claim 1 wherein:
Each short panel comprises a plurality of ribs on the outside surface, along the vertical and the horizontal direction for strength. Said short panel having cutout in the middle, near the upper edge for gripping. Also said short panel having a corner bent 90 degrees allowing said short panel be folded flat against the long panel surface. Said short panel, one end having two female slots, other end having one male plug and one female slot to engage a corresponding slot in the long panel. Further said short panel having additional two male plugs on the inside surface, along the bottom edge to engage another corresponding female slots in the bottom panel.

5. A foldable utility container/carrier in accordance with claim 1 wherein:
Each bottom panel comprises a plurality of ribs for strength. Said bottom panel, one end having two female slots to engage a corresponding plug in the short panel, and said bottom panel also having notches on the bottom-side surface to engage a corresponding stoppers on the long panel when said bottom panel is in fully expanded position.

6. A foldable utility container/carrier in accordance with claim 1 wherein:
Each divider having two female slots at one end to engage a corresponding plugs in the bottom panel. Said divider also having cutout for gripping purpose.

7. A foldable utility container/carrier in accordance with claim 5 wherein:
The plurality of ribs comprises of 9 compartments. Two compartments on the row adjacent to the hinge-end of said 9 compartments-One having Velcro pad, and other having magnet pad.

8. A foldable utility container/carrier in accordance with claim 4 wherein:
Each said short panel also having two half-inch round holes near top corner as provision for bungee cords hookup.

9. A foldable utility container/carrier with claim 5 wherein:
Each bottom panel is having two male plugs to engage a corresponding female slots on the divider.
